(19) United States
(12) Patent Application Publication
(10) Pub. No.: US 2026/0284793 A1
(43) Pub. Date: Sep. 24, 2026

(54) DEVICE FOR CUTTING ELECTRODE

(71) Applicant: SK ON CO., LTD., Seoul (KR)

(72) Inventors: Yoong Hee LEE, Daejeon (KR); Ohsan AN, Daejeon (KR); Jae Hun KIM, Daejeon (KR); Ji Yoon YOUM, Daejeon (KR)

(21) Appl. No.: 19/568,818

(22) Filed: Mar. 17, 2026

(30) Foreign Application Priority Data
Mar. 18, 2025 (KR) 10-2025-0034627

(51) Int. Cl. B23K 26/38; B23K 26/082; H01M 4/04

(52) U.S. Cl. CPC B23K 26/38; B23K 26/082; H01M 4/04

(57) ABSTRACT

Disclosed is a device for cutting an electrode. According to an embodiment of the present disclosure, there may be provided a device for cutting an electrode including a guide rail extending in a longitudinal direction thereof; a scanner unit including a scanner frame movably coupled to the guide rail and a mirror assembly coupled to the scanner frame; and a scanner drive coupled to the scanner frame and configured to drive the scanner frame, wherein the mirror assembly includes a first mirror that obliquely faces a first laser beam incident while traveling in the longitudinal direction of the guide rail.

### CROSS-REFERENCE TO RELATED APPLICATION

This patent application claims the priority and benefits of Korean patent application No. 10-2025-0034627, filed on Mar. 18, 2025, the disclosure of which is incorporated herein by reference in its entirety.

### BACKGROUND OF THE INVENTION

### 1. Field of the Invention

The present disclosure relates to a device for cutting an electrode.

### 2. Description of the Related Art

An electrode having a sheet shape may be unrolled from a roll and transported, and may be cut and used in a secondary battery. In a process of cutting the sheet-shaped electrode (hereinafter referred to as an “electrode sheet”), a cutter (such as a laser) cuts the electrode sheet while transportation of the electrode sheet is stopped. To increase process efficiency, research may be needed into cutting the electrode sheet while the electrode sheet is being transported.

### SUMMARY OF THE INVENTION

An object of the present disclosure is to provide a device for cutting an electrode configured to cut an electrode sheet while the electrode sheet is being transported.

A device for cutting an electrode according to the present disclosure may include: a guide rail extending in a longitudinal direction thereof; a scanner unit including a scanner frame movably coupled to the guide rail and a mirror assembly coupled to the scanner frame; and a scanner drive coupled to the scanner frame and configured to drive the scanner frame, wherein the mirror assembly may include a first mirror that obliquely faces a first laser beam incident while traveling in the longitudinal direction of the guide rail.

The scanner drive may include: a disk motor configured to generate a rotational force; a coupling disk fixed to the disk motor; and a coupling rod having one end pivotally coupled to the coupling disk and the other end pivotally coupled to the scanner frame.

The mirror assembly may include a second mirror that obliquely faces the first mirror, and the scanner unit may include: a mirror shaft coupled to the second mirror; and a mirror motor coupled to the mirror shaft.

A longitudinal direction of a rotational axis of the mirror shaft may correspond to the longitudinal direction of the guide rail.

The mirror motor may be fixed to the scanner frame.

The device for cutting an electrode may further include a position sensor configured to measure a position of the mirror assembly relative to the guide rail.

The device for cutting an electrode may further include a control unit configured to receive position information of the mirror assembly from the position sensor and to control the mirror motor based on the position information.

The coupling disk may have a circular disk shape.

The scanner drive may include: a cam motor configured to generate a rotational force; and a coupling cam fixed to the cam motor and in contact with the scanner frame, wherein a distance between a point of contact between the coupling cam and the scanner frame and a center of rotation of the coupling cam may vary depending on rotation of the coupling cam.

The coupling cam and the scanner frame may be disposed in the longitudinal direction of the guide rail.

The device for cutting an electrode may further include a pusher configured to apply a force to the scanner frame in a direction from the scanner frame toward the coupling cam.

The scanner drive may include: a stator extending in the longitudinal direction of the guide rail and coupled to the guide rail; and a mover coupled to the scanner frame and facing the stator.

When alternating current (AC) power is applied to the stator, a linear force may be generated in the mover.

The device for cutting an electrode may further include a position sensor configured to measure a position of the mirror assembly relative to the guide rail.

The position sensor may include: a linear rod extending in the longitudinal direction of the guide rail; and a linear lead coupled to the scanner frame and facing the linear rod.

The device for cutting an electrode may further include a control unit configured to control the stator based on position information of the mirror assembly acquired from the position sensor.

The position sensor may measure a transport speed of the electrode sheet disposed below the mirror assembly and transported in a direction intersecting the longitudinal direction of the guide rail, and the control unit may control the stator based on information regarding the position of the mirror assembly and the transport speed of the electrode sheet.

The mirror assembly may include a second mirror that obliquely faces the first mirror, and the scanner unit may include: a mirror shaft coupled to the second mirror; a scanner gear fixed to the mirror shaft; and a guide gear extending in the longitudinal direction of the guide rail and meshed with the scanner gear.

The scanner gear may include: a first scanner gear rotatably coupled to the scanner frame and meshed with the guide gear to rotate when the scanner frame moves; and a second scanner gear extending from the rotational axis of the mirror shaft and meshed with the first scanner gear.

A coupling structure between the first scanner gear and the guide gear may be a pinion-rack coupling structure, and a coupling structure between the first scanner gear and the second scanner gear may be a bevel-gear coupling structure.

According to an embodiment of the present disclosure, there may be provided a device for cutting an electrode configured to cut an electrode sheet while the electrode sheet is being transported.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a perspective view illustrating a state in which an electrode sheet is transported;

FIG. 2 is a front view illustrating a device for cutting an electrode (hereinafter also referred to as an “electrode cutting device”) 10 according to an embodiment of the present disclosure;

FIG. 3 is a cross-sectional view of the electrode cutting device 10, taken along line A1-A2 of FIG. 2;

FIG. 4 is a view illustrating a state in which a laser irradiates a mirror assembly coupled to a scanner frame shown in FIG. 3 with a first laser beam;

FIG. 5 is a perspective view illustrating a state in which a mirror shaft and a mirror motor are coupled to a second mirror shown in FIG. 4;

FIG. 6 is a perspective view illustrating a state in which a disk unit is coupled to the scanner unit shown in FIG. 2;

FIG. 7 is a bottom view illustrating the scanner unit and the disk unit shown in FIG. 6;

FIG. 8 is a perspective view illustrating a state in which the electrode cutting device is disposed above the electrode shown in FIG. 1;

FIG. 9 is an exploded cross-sectional view of the scanner unit and the guide unit shown in FIG. 3, in which a linear drive and a position sensor are illustrated;

FIG. 10 is a perspective view illustrating a mirror gear module according to an embodiment of the present disclosure;

FIG. 11 is a bottom view illustrating a cam unit coupled to the scanner unit;

FIG. 12 is a plan view illustrating a state in which the guide unit is disposed on the electrode sheet shown in FIG. 1 and is positioned diagonally with respect to a width direction of the electrode sheet; and

FIG. 13 is a block diagram of the electrode cutting device according to an embodiment of the present disclosure.

### DETAILED DESCRIPTION OF THE INVENTION

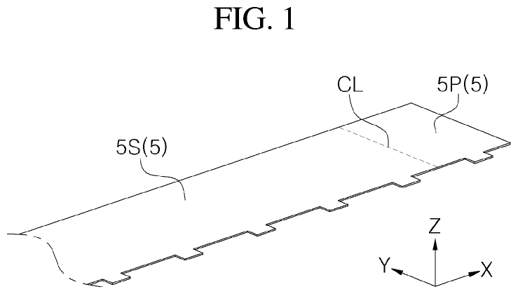

Hereinafter, exemplary embodiments of the present disclosure will be described in detail with reference to the accompanying FIGS. 1 to 13. However, these embodiments are merely illustrative, and the present disclosure is not limited to the specific embodiments described as examples.

A Cartesian coordinate system may be used herein. For example, the Cartesian coordinate system may be a right-handed coordinate system.

For example, a positive X-axis may represent the forward direction. For example, a positive Y-axis may represent the left direction. For example, a positive Z-axis may represent the upward direction.

For example, a negative X-axis may represent the rearward direction. For example, a negative Y-axis may represent the rightward direction. For example, a negative Z-axis may represent the downward direction.

A cylindrical coordinate system may be used herein. The Z-axis of the cylindrical coordinate system may be the same as the Z-axis of the Cartesian coordinate system. In the cylindrical coordinate system, a radial direction and an azimuthal direction may be set relative to the Z-axis of the cylindrical coordinate system.

FIG. 1 is a perspective view illustrating a state in which an electrode sheet is transported.

Referring to FIG. 1, an electrode sheet 5S may extend in one direction. For example, the electrode sheet 5S may extend in the front-rear direction. For example, a direction in which the electrode sheet 5S extends may correspond to the front-rear direction.

For example, the direction in which the electrode sheet 5S extends may be a longitudinal direction of the electrode sheet 5S. The electrode sheet 5S may be transported in the longitudinal direction of the electrode sheet 5S. For example, the electrode sheet 5S may be transported in the forward direction.

The electrode sheet 5S may define opposite edges. The opposite edges of the electrode sheet 5S may have shapes extending in the longitudinal direction of the electrode sheet 5S.

A width direction of the electrode sheet 5S may correspond to a direction between the opposite edges of the electrode sheet 5S. For example, the width direction of the electrode sheet 5S may correspond to the left-right direction. The width direction of the electrode sheet 5S may intersect the longitudinal direction of the electrode sheet 5S.

The electrode sheet 5S may be cut or notched. For example, the electrode sheet 5S may be cut along a cutting line CL. The cutting line CL may extend across the electrode sheet 5S in the width direction of the electrode sheet 5S. The cutting line CL may be a virtual line located on one surface of the electrode sheet 5S.

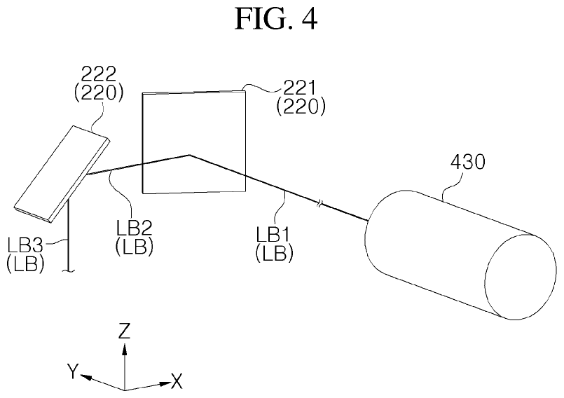

For example, while transportation of the electrode sheet 5S is stopped, a laser 430 (see FIG. 4) may irradiate the electrode sheet 5S with a laser beam LB (see FIG. 4) along the cutting line CL.

An individual electrode 5P separated from the electrode sheet 5S may be collected, and transportation of the electrode sheet 5S may be started. Thereafter, the transportation of the electrode sheet 5S may be stopped, and the electrode sheet 5S may be cut.

In this way, for the laser 430 (see FIG. 4) to cut the electrode sheet 5S, the electrode sheet 5S may be in a stopped state. If the electrode sheet 5S is cut while the electrode sheet 5S is being transported, the efficiency of a process of cutting the electrode sheet 5S may be increased.

An electrode 5 may include or refer to at least one of the electrode sheet 5S and the individual electrode 5P. The electrode 5 may define two surfaces. For example, the electrode 5 may define an upper face and a lower face. The upper face of electrode 5 may face or be directed upward. The lower face of electrode 5 may face or be directed downward.

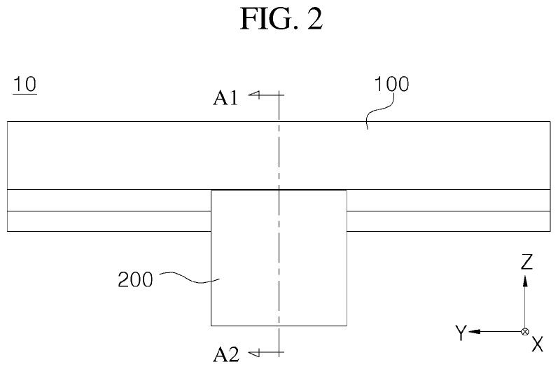

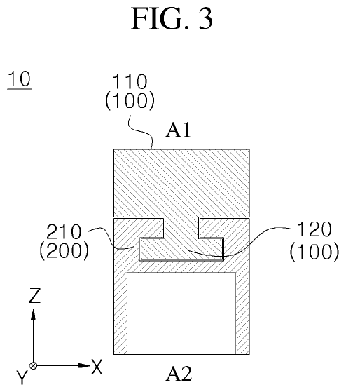

FIG. 2 is a front view illustrating an electrode cutting device 10 according to an embodiment of the present disclosure. FIG. 3 is a cross-sectional view of the electrode cutting device 10, taken along line A1-A2 of FIG. 2. FIG. 4 is a view illustrating a state in which a laser irradiates a mirror assembly coupled to a scanner frame shown in FIG. 3 with a first laser beam.

Referring to FIGS. 1 to 4, the electrode cutting device 10 may include a guide unit 100. The guide unit 100 may include a guide frame 110.

The guide unit 100 may include a guide rail 120. The guide rail 120 may be connected, coupled, or formed on the guide frame 110. For example, the guide rail 120 may extend or protrude from the guide frame 110.

For example, the guide rail 120 may have a shape extending in one direction. For example, a longitudinal direction of the guide rail 120 may correspond to a direction in which the guide rail 120 extends. For example, the longitudinal direction of the guide rail 120 may correspond to the width direction of the electrode sheet 5S.

The electrode cutting device 10 may include a scanner unit 200. The scanner unit 200 may include a scanner frame 210. The scanner frame 210 may be connected to the guide rail 120.

For example, the scanner frame 210 may be movably coupled to the guide rail 120. For example, the scanner frame 210 may move along the guide rail 120.

The scanner unit 200 may include a mirror assembly 220. The mirror assembly 220 may be installed, connected, fixed, or coupled to the scanner frame 210.

The mirror assembly 220 may include at least one mirror. For example, the mirror assembly 220 may include at least one of a first mirror 221 and a second mirror 222.

For example, the mirror assembly 220 may refer to at least one of the first mirror 221 and the second mirror 222. The mirror assembly 220 may reflect at least a portion of incident light.

The mirror assembly 220 may face or be directed obliquely toward the longitudinal direction of the guide rail 120 (see FIG. 3). For example, the first mirror 221 may face or be directed obliquely toward the laser 430.

The mirror assembly 220 may face or directed obliquely toward a radial direction of the guide rail 120 (see FIG. 3). For example, the second mirror 222 may face or be directed obliquely toward the radial direction of the guide rail 120 (see FIG. 3).

The radial direction of the guide rail 120 (see FIG. 3) may correspond to a radial direction of a cylindrical coordinate system in which the longitudinal direction of the guide rail 120 (see FIG. 3) is an axial direction.

The mirror assembly 220 may face or be directed toward a direction between the longitudinal direction and the radial direction of the guide rail 120 (see FIG. 3). For example, the first mirror 221 may face or be directed toward a direction between the longitudinal direction and the radial direction of the guide rail 120 (see FIG. 3).

For example, the laser 430 may irradiate the first mirror 221 with a first laser beam LB1. A direction in which the first laser beam LB1 travels may be parallel to a direction in which the scanner unit 200 moves. For example, the first laser beam LB1 may travel along the Y-axis.

At least a portion of the first laser beam LB1 may be reflected from the first mirror 221. A second laser beam LB2 may be a laser beam formed by reflection of the first laser beam LB1 at the first mirror 221.

The second laser beam LB2 may travel from the first mirror 221 toward the second mirror 222. For example, the second mirror 222 may obliquely face the first mirror 221.

At least a portion of the second laser beam LB2 may be reflected from the second mirror 222. A third laser beam LB3 may be a laser beam formed by reflection of the second laser beam LB2 at the second mirror 222.

The third laser beam LB3 may be directed downward from the second mirror 222. For example, the third laser beam LB3 may travel from the second mirror 222 toward the electrode sheet 5S.

A process of cutting the electrode sheet 5S while transportation of the electrode sheet 5S is stopped will be described as follows. For example, the longitudinal direction of the guide rail 120 may correspond to the width direction of the electrode sheet 5S. For example, the scanner unit 200 may move in the width direction of the electrode sheet 5S.

When the first laser beam LB1 is incident on the mirror assembly 220, the third laser beam LB3 may be irradiated onto the electrode sheet 5S from the mirror assembly 220. When the scanner unit 200 moves in the width direction of the electrode sheet 5S while transportation of the electrode sheet 5S is stopped, the third laser beam LB3 may cut the electrode sheet 5S along the cutting line CL.

When the electrode sheet 5S is cut while transportation of the electrode sheet 5S is stopped, the mirror assembly 220 may include only one of the first mirror 221 and the second mirror 222. For example, the first laser beam LB1 may be incident on the first mirror 221, and the second laser beam LB2 may travel from the first mirror 221 toward the electrode sheet 5S.

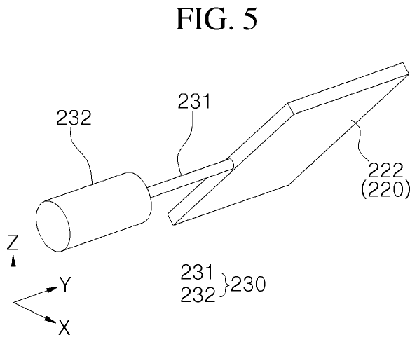

FIG. 5 is a perspective view illustrating a state in which a mirror shaft and a mirror motor are coupled to the second mirror shown in FIG. 4.

Referring to FIGS. 1 to 5, the scanner unit 200 may include a mirror drive 230. The mirror drive 230 may be connected, coupled, or installed on the scanner frame 210.

The mirror drive 230 may include a mirror shaft 231. The mirror shaft 231 may be connected or coupled to the second mirror 222. The mirror shaft 231 may define a rotational axis.

The mirror drive 230 may include a mirror motor 232. The mirror motor 232 may be connected or coupled to the mirror shaft 231. The mirror motor 232 may provide a rotational force to the mirror shaft 231.

When the mirror shaft 231 rotates about the rotational axis, the second mirror 222 may rotate. For example, when the second mirror 222 rotates, a path of the third laser beam LB3 may change in the front-rear direction.

The process of cutting the electrode sheet 5S while the electrode sheet 5S is being transported will be described as follows. For example, when the electrode sheet 5S is transported, the cutting line CL may move. For example, the cutting line CL may move in the forward direction.

When the cutting line CL moves in the longitudinal direction of the electrode sheet 5S and the scanner unit 200 moves in the width direction of the electrode sheet 5S, as the second mirror 222 rotates, the third laser beam LB3 may cut the electrode sheet 5S along the cutting line CL.

For example, the first mirror 221 and the second mirror 222 may be disposed in the width direction of the electrode sheet 5S. The mirror drive 230 may rotate the second mirror 222 about the mirror shaft 231.

The rotational axis of the mirror shaft 231 may extend in a direction across the electrode sheet 5S. For example, the rotational axis of the mirror shaft 231 may extend in the width direction of the electrode sheet 5S. For example, the longitudinal direction of the electrode sheet 5S may be parallel to the X-axis, and the rotational axis of the mirror shaft 231 may be parallel to the Y-axis.

When the second mirror 222 rotates about the mirror shaft 231, the second mirror 222 may sweep the third laser beam LB3 along the longitudinal direction of the electrode sheet 5S.

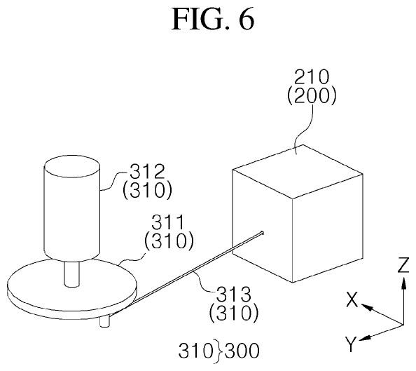

FIG. 6 is a perspective view illustrating a state in which a disk unit is coupled to the scanner unit shown in FIG. 2.

Referring to FIG. 6, the electrode cutting device 10 may include a scanner drive 300. The scanner drive 300 may include a disk unit 310.

The disk unit 310 may include a coupling disk 311. The coupling disk 311 may have a circular disk shape. As another example, the coupling disk 311 may have a bar shape.

The disk unit 310 may include a disk motor 312. The disk motor 312 may be coupled to the coupling disk 311. For example, the coupling disk 311 may receive a rotational force from the disk motor 312.

When the disk motor 312 rotates, the coupling disk 311 may rotate. When the coupling disk 311 rotates, angular momentum of the coupling disk 311 may be generated. The angular momentum may be a vector having a direction and a magnitude.

A direction of the angular momentum of the coupling disk 311 may differ from the longitudinal direction of the guide rail 120 (see FIG. 3). For example, the direction of the angular momentum of the coupling disk 311 may differ from a movement direction of the scanner unit 200.

For example, the angular momentum of the coupling disk 311 may have at least one of an X-axis component and a Z-axis component. For example, the angular momentum of the coupling disk 311 may be parallel to the XZ plane.

The disk unit 310 may include a coupling rod 313. The coupling rod 313 may connect the scanner frame 210 and the coupling disk 311. For example, the coupling rod 313 may be pivotally coupled to the scanner frame 210. For example, the coupling rod 313 may be pivotally coupled to the coupling disk 311.

For example, the coupling rod 313 may extend from one end to the other end. For example, one end of the coupling rod 313 may be pivotally coupled to the coupling disk 311, and the other end of the coupling rod 313 may be pivotally coupled to the scanner frame 210.

A distance between one end of the coupling rod 313 and the scanner frame 210 may be set based on, for example, the movement direction of the scanner unit 200.

For example, the distance between one end of the coupling rod 313 and the scanner frame 210 may refer to a distance between one end of the coupling rod 313 and the scanner frame 210 measured along an extension line of the guide rail 120 (see FIG. 3).

For example, the distance between one end of the coupling rod 313 and the scanner frame 210 may refer to a distance between a Y-axis component of a position of one end of the coupling rod 313 and a Y-axis component of a position of the scanner frame 210.

The distance between one end of the coupling rod 313 and the scanner frame 210 may vary depending on rotation of the coupling disk 311. Therefore, when the coupling disk 311 rotates, the scanner frame 210 may reciprocate along the guide rail 120 (see FIG. 3).

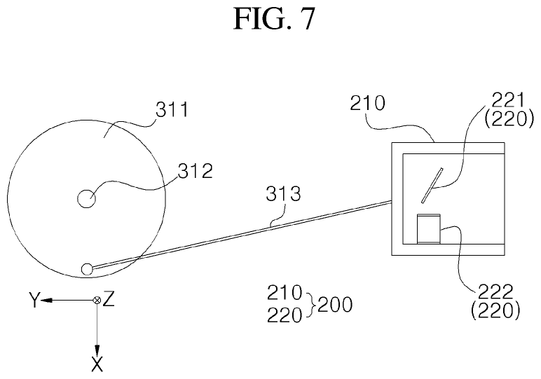

FIG. 7 is a bottom view illustrating the scanner unit and the disk unit shown in FIG. 6.

Referring to FIGS. 6 and 7, the scanner frame 210 may define a space therein. The space formed in the scanner frame 210 may be open toward the laser 430 (see FIG. 4). The space formed in the scanner frame 210 may be open toward the electrode 5 (see FIG. 1).

The mirror assembly 220 may be coupled to the scanner frame 210. For example, at least a portion of the mirror assembly 220 may be positioned in the space formed in the scanner frame 210. For example, at least a portion of the mirror assembly 220 may be accommodated in the space formed in the scanner frame 210.

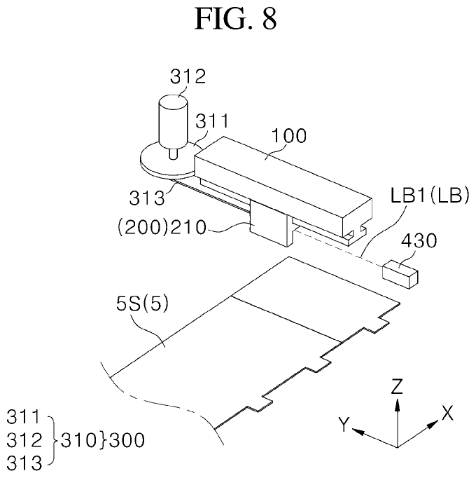

FIG. 8 is a perspective view illustrating a state in which the electrode cutting device is disposed above the electrode shown in FIG. 1.

Referring to FIGS. 6 to 8, the electrode cutting device 10 may be disposed above the electrode sheet 5S. For example, the guide unit 100 may be positioned above the electrode sheet 5S. For example, the scanner unit 200 may be positioned above the electrode sheet 5S.

The laser 430 may provide the first laser beam LB1 to the scanner unit 200. The mirror assembly 220 may reflect the first laser beam LB1 to form a second laser beam LB2, and may reflect the second laser beam LB2 to form a third laser beam LB3.

The third laser beam LB3 may be irradiated onto the electrode sheet 5S. The scanner drive 300 may move the scanner frame 210 in the longitudinal direction of the guide rail 120 (see FIG. 3). For example, the mirror assembly 220 may move in the longitudinal direction of the guide rail 120 (see FIG. 3).

As the electrode sheet 5S moves in the longitudinal direction thereof, the cutting line CL (see FIG. 1) may move in a transport direction of the electrode sheet 5S. Therefore, the second mirror 222 needs to rotate such that the third laser beam LB3 traces the cutting line CL (see FIG. 1).

A degree of rotation of the second mirror 222 may be calculated by a function having as variables a transport speed of the electrode sheet 5S, a movement speed of the scanner frame 210, and a relative position of the mirror assembly 220 with respect to the guide rail 120 (see FIG. 3).

For example, if the transport speed of the electrode sheet 5S is high, the degree of rotation of the second mirror 222 may increase. For example, if the movement speed of the scanner frame 210 is high, the degree of rotation of the second mirror 222 may decrease.

For example, the mirror assembly 220 may move from one end of the guide rail 120 (see FIG. 3) to the other end to cut the electrode sheet 5S. For example, as the distance between one end of the guide rail 120 (see FIG. 3) and the mirror assembly 220 increases, the degree of rotation of the second mirror 222 may increase.

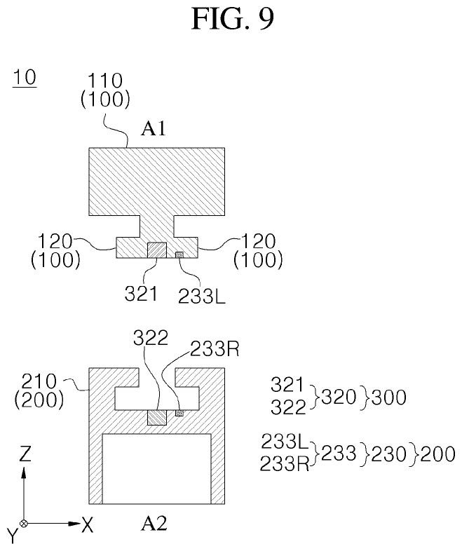

FIG. 9 is an exploded cross-sectional view of the scanner unit and the guide unit shown in FIG. 3, in which a linear drive and a position sensor are illustrated.

Referring to FIGS. 2, 3, and 9, the scanner drive 300 may include a linear drive 320. The linear drive 320 may include a stator 321 and a mover 322.

The stator 321 may be coupled to the guide unit 100. For example, the stator 321 may be connected or coupled to the guide rail 120. For example, the stator 321 may be formed along the guide rail 120.

For example, a longitudinal direction of the stator 321 may be parallel to the longitudinal direction of the guide rail 120. For example, a longitudinal direction of the stator 321 may correspond to a direction in which the stator 321 extends. For example, the stator 321 may have a shape extending in the longitudinal direction of the stator 321.

The mover 322 may be connected or coupled to the scanner unit 200. For example, the mover 322 may be coupled to the scanner frame 210. The mover 322 may be disposed adjacent to the stator 321. For example, the mover 322 may face the stator 321.

Electric power may be applied to the stator 321. For example, at least one of current and voltage may be applied to the stator 321. For example, alternating current (AC) power may be applied to the stator 321.

When power is applied to the stator 321, the stator 321 and the mover 322 may be magnetically coupled to each other. Accordingly, the mover 322 may receive a linear force from the stator 321. In other words, a linear force may be generated in the mover 322 by the stator 321. A direction of the linear force applied to the mover 322 may correspond to the longitudinal direction of the stator 321.

The linear drive 320 may move the mirror assembly 220 (see FIGS. 4 and 7) at a constant velocity. For example, by the linear drive 320, the mirror assembly 220 (see FIGS. 4 and 7) may move at a constant velocity above the cutting line CL (see FIG. 1).

When the mirror assembly 220 (see FIGS. 4 and 7) moves at a constant velocity above the cutting line CL (see FIG. 1), the electrode sheet 5S (see FIG. 1) moves at a constant velocity, and the guide rail 120 forms an angle with respect to the electrode sheet 5S (see FIG. 1), the electrode sheet 5S (see FIG. 1) may be cut along the cutting line CL (see FIG. 1) while the second mirror 222 (see FIGS. 4 and 7) is fixed to the scanner frame 210.

The mirror drive 230 may include a position sensor 233. The position sensor 233 may measure, for example, a position of the mirror assembly 220 (see FIGS. 4 and 7) relative to the guide rail 120.

The position sensor 233 may include a linear rod 233L. The linear rod 233L may have a shape extending in the longitudinal direction. The longitudinal direction of the linear rod 233L may be the same as the longitudinal direction of the guide rail 120.

The linear rod 233L may be coupled or connected to the guide unit 100. For example, the linear rod 233L may be coupled or connected to the guide rail 120.

The position sensor 233 may include a linear lead 233R. The linear lead 233R may be connected or coupled to the scanner frame 210. For example, the linear lead 233R may be disposed adjacent to the linear rod 233L. For example, the linear lead 233R may face the linear rod 233L.

Depending on the position of the linear lead 233R relative to the linear rod 233L, a value measured by the linear lead 233R may vary. Thus, the position sensor 233 may measure the position of the mirror assembly 220 (see FIGS. 4 and 7) relative to the guide rail 120.

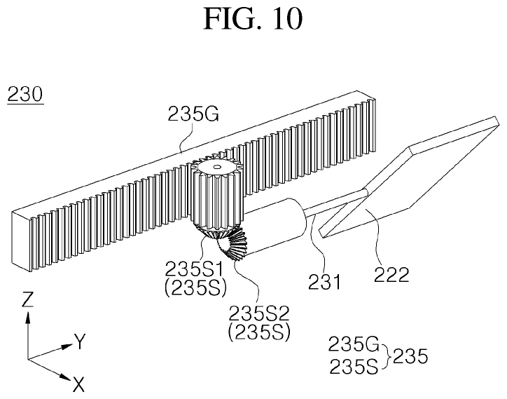

FIG. 10 is a perspective view illustrating a mirror gear module according to an embodiment of the present disclosure.

Referring to FIG. 10, the mirror drive 230 may include a mirror gear module 235. The mirror gear module 235 may include a guide gear 235G. The guide gear 235G may be coupled or fixed to the guide unit 100 (see FIG. 9).

The guide gear 235G may have a shape extending in the longitudinal direction. A longitudinal direction of the guide gear 235G may correspond to the longitudinal direction of the guide rail 120 (see FIG. 9). The guide gear 235G may include threads formed thereon along the longitudinal direction of the guide gear 235G.

The mirror gear module 235 may include a scanner gear 235S. The scanner gear 235S may be connected or coupled to the scanner frame 210 (see FIG. 9). When the scanner frame 210 (see FIG. 9) moves on the guide rail 120, the scanner gear 235S may move along the guide gear 235G.

The scanner gear 235S may include a first scanner gear 235S1. The first scanner gear 235S1 may be rotatably coupled to the scanner frame 210. For example, a rotational axis of the first scanner gear 235S1 may be coupled to the scanner frame 210.

For example, the first scanner gear 235S1 may have a shape extending from the mirror shaft 231 in the longitudinal direction of the mirror shaft 231. For example, the rotational axis of the first scanner gear 235S1 may extend in the longitudinal direction of the mirror shaft 231 from the rotational axis of the mirror shaft 231.

The first scanner gear 235S1 may have a plurality of threads formed on an outer circumferential surface thereof. For example, the plurality of threads formed on the first scanner gear 235S1 may be disposed in an azimuthal direction relative to the rotational axis of the first scanner gear 235S1.

The first scanner gear 235S1 may be meshed with the guide gear 235G. For example, the threads formed on the first scanner gear 235S1 may be meshed with the threads formed on the guide gear 235G.

For example, the coupling structure between the first scanner gear 235S1 and the guide gear 235G may be a pinion-rack coupling structure. For example, the first scanner gear 235S1 may be a pinion gear and the guide gear 235G may be a rack gear.

When the scanner frame 210 (see FIG. 9) moves on the guide rail 120, the first scanner gear 235S1 may rotate while being meshed with the guide gear 235G. An amount of rotation of the first scanner gear 235S1 may depend on a position of the scanner frame 210 (see FIG. 9) relative to a reference point of the guide rail 120.

The scanner gear 235S may include a second scanner gear 235S2. The second scanner gear 235S2 may be meshed with the first scanner gear 235S1. A rotational axis of the second scanner gear 235S2 may intersect the rotational axis of the first scanner gear 235S1. For example, a coupling structure between the first scanner gear 235S1 and the second scanner gear 235S2 may be a bevel-gear coupling structure.

For example, the rotational axis of the first scanner gear 235S1 may be formed in the XZ plane. For example, the rotational axis of the first scanner gear 235S1 may be parallel to the Z-axis. For example, the rotational axis of the second scanner gear 235S2 may be parallel to the longitudinal direction of the guide rail 120 (see FIG. 9).

The second scanner gear 235S2 may be coupled or fixed to the mirror shaft 231. For example, the second scanner gear 235S2 and the mirror shaft 231 may be coaxial with each other.

When the scanner frame 210 (see FIG. 9) moves on the guide rail 120, the first scanner gear 235S1 may rotate while being meshed with the guide gear 235G. When the first scanner gear 235S1 rotates, the second scanner gear 235S2 may rotate.

When the second scanner gear 235S2 rotates, the mirror shaft 231 may rotate. When the mirror shaft 231 rotates, the second mirror 222 may rotate. Accordingly, when the scanner frame 210 (see FIG. 9) moves on the guide rail 120, the second mirror 222 may rotate.

The amount of rotation of the first scanner gear 235S1 may vary depending on a position of the scanner frame 210 (see FIG. 9) relative to the reference point of the guide rail 120. An amount of rotation of the second scanner gear 235S2 may vary depending on the amount of rotation of the first scanner gear 235S1. The amount of rotation of the second mirror 222 may correspond to the amount of rotation of the second scanner gear 235S2.

Accordingly, the amount of rotation of the second mirror 222 may be determined based on the position of the scanner frame 210 (see FIG. 9) relative to the reference point of the guide rail 120. For example, the amount of rotation of the second mirror 222 may be proportional to a distance between the reference point of the guide rail 120 and the scanner frame 210 (see FIG. 9).

Referring to FIGS. 1 to 10, when the guide rail 120 is disposed parallel to the cutting line CL, and the linear drive 320 moves the scanner unit 200, the mirror gear module 235 may rotate the second mirror 222 such that the electrode sheet 5S is cut along the cutting line CL.

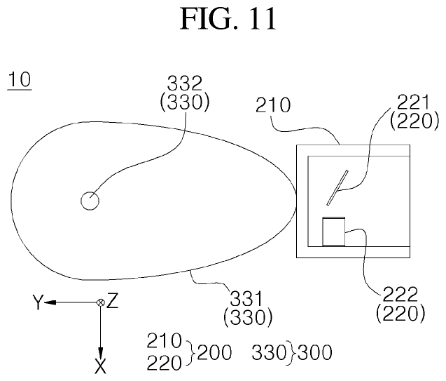

FIG. 11 is a bottom view illustrating the cam unit coupled to the scanner unit. In FIG. 11, a shaft of the cam motor 332 may be indicated for convenience of description.

Referring to FIG. 11, the scanner drive 300 may include a cam unit 330. The cam unit 330 may include a cam motor 332. The cam motor 332 may generate a rotational force.

The cam unit 330 may include a coupling cam 331. The coupling cam 331 may be fixed to the cam motor 332. When the cam motor 332 rotates, the coupling cam 331 may rotate.

A center of rotation of the coupling cam 331 may be a connection portion between the cam motor 332 and the coupling cam 331. A distance between the center of rotation of the coupling cam 331 and an outer circumferential surface of the coupling cam 331 may vary depending on a point on the outer circumferential surface of the coupling cam 331. The center of rotation of the coupling cam 331 may correspond to a rotational axis of the cam motor 332.

The outer circumferential surface of the coupling cam 331 may form a curve. For example, the outer circumferential surface of the coupling cam 331 may form at least one of at least a portion of a circle and at least a portion of an ellipse. For example, a curvature (or a radius of curvature) of the outer circumferential surface of the coupling cam 331 may not be constant along the outer circumferential surface of the coupling cam 331.

For example, the coupling cam 331 may be symmetrical with respect to a reference plane passing through the center of rotation of the coupling cam 331. For example, the coupling cam 331 may be asymmetrical with respect to another plane passing through the center of rotation of the coupling cam 331. The other plane may be a plane different from the reference plane.

For example, a distance between a contact point between the coupling cam 331 and the scanner frame 210 and the center of rotation of the coupling cam 331 may vary depending on rotation of the coupling cam 331.

For example, the coupling cam 331 may have an egg shape or a pear shape. In this context, the coupling cam 331 may be referred to as an “egg-shaped cam” or a “pear-shaped cam.”

The coupling cam 331 and the scanner frame 210 may be disposed in the longitudinal direction of the guide rail 120 (see FIG. 3). The coupling cam 331 may contact the scanner frame 210. For example, contact between an outer circumferential surface of the coupling cam 331 and an outer surface of the scanner frame 210 may be maintained.

A force may be applied to the scanner frame 210 in a direction from the scanner frame 210 toward the coupling cam 331. For example, a pusher (not shown) may push the scanner frame 210 toward the coupling cam 331.

For example, an elastic member (not shown) may provide an elastic force to the scanner frame 210, and contact between the outer circumferential surface of the coupling cam 331 and the outer surface of the scanner frame 210 may be maintained.

A direction of angular momentum of the coupling cam 331 may lie in the XZ plane. For example, a rotational axis of the coupling cam 331 may be parallel to the Z-axis. When the coupling cam 331 rotates, a distance between the center of rotation of the coupling cam 331 and the scanner frame 210 may vary. Accordingly, the scanner frame 210 may reciprocate along the guide rail 120 (see FIG. 3).

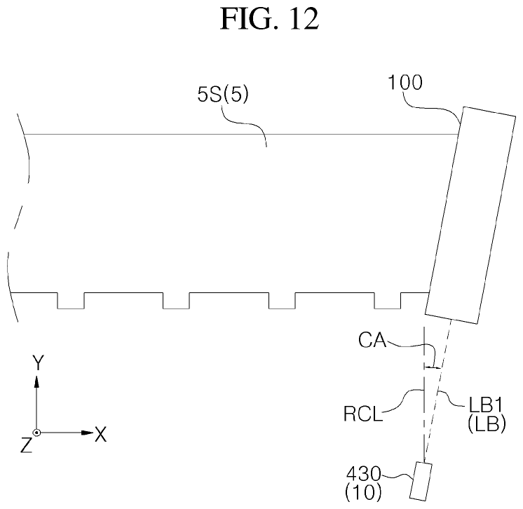

FIG. 12 is a plan view illustrating a state in which the guide unit is disposed on the electrode sheet shown in FIG. 1 and is positioned diagonally with respect to the width direction of the electrode sheet.

Referring to FIGS. 1, 4, 9, and 12, a reference cutting line RCL may be a virtual line parallel to the cutting line CL and connected to the laser 430. The laser 430 may irradiate the mirror assembly 220 with the first laser beam LB1.

The longitudinal direction of the guide rail 120 may form an angle with the reference cutting line RCL. A cutting angle CA may correspond to an angle formed between the longitudinal direction of the guide rail 120 and the reference cutting line RCL. For example, the cutting angle CA may be an angle formed between the reference cutting line RCL and the first laser beam LB1.

When the electrode sheet 5S is transported at a constant velocity in the longitudinal direction of the electrode sheet 5S, the guide rail 120 forms the cutting angle CA with the reference cutting line RCL, and the mirror assembly 220 moves along the guide rail 120 at a constant velocity, the mirror assembly 220 may be positioned above the cutting line CL.

In other words, when the electrode sheet 5S is transported at a constant velocity in the longitudinal direction of the electrode sheet 5S, the guide rail 120 forms the reference cutting line RCL and the cutting angle CA, and the mirror assembly 220 moves on the guide rail 120 at a constant velocity, the third laser beam LB3 may be irradiated onto the cutting line CL while the second mirror 222 is fixed to the scanner frame 210.

Accordingly, when the electrode sheet 5S is transported at a constant velocity in the longitudinal direction of the electrode sheet 5S, and the guide rail 120 forms the reference cutting line RCL and a cutting angle CA, the mirror assembly 220 may include a single mirror fixed to the scanner frame 210.

For example, the mirror assembly 220 may include the first mirror 221 fixed to the scanner frame 210 and obliquely facing the laser 430 and the electrode sheet 5S. In this case, the second laser beam LB2 reflected from the first mirror 221 may be irradiated onto the electrode sheet 5S.

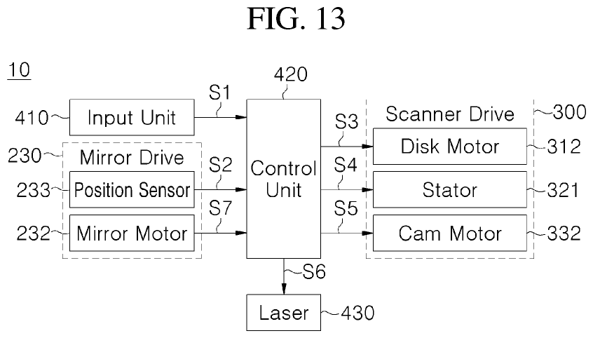

FIG. 13 is a block diagram of the electrode cutting device according to an embodiment of the present disclosure.

Referring to FIGS. 1 to 13, the electrode cutting device 10 may include an input unit 410. The input unit 410 may acquire input from a user or the like.

The input unit 410 may generate a first signal S1. The first signal S1 may include information regarding the input acquired by the input unit 410. For example, the first signal S1 may include operational information regarding at least one of the mirror drive 230, the scanner drive 300, and the laser 430.

The electrode cutting device 10 may include a control unit 420. The control unit 420 may perform calculations. The control unit 420 may process signals. The control unit 420 may transmit and receive signals.

For example, the control unit 420 may be implemented through at least one of a processor, a central processing unit (CPU), a graphical processing unit (GPU), an electric circuit, a circuit board, a computer, and a server.

The position sensor 233 may generate a second signal S2. The second signal S2 may include information regarding a position of the mirror assembly 220 relative to the guide rail 120. For example, the second signal S2 may include information regarding the position of the mirror assembly 220 relative to the reference point of the guide rail 120.

The position sensor 233 may include, for example, the linear rod 233L and the linear lead 233R. In other words, the position sensor 233 may include a linear scale sensor. In another example, the position sensor 233 may include at least one of a laser sensor, an ultrasonic sensor, and a vision sensor.

In another example, the position sensor 233 may measure a position of the electrode sheet 5S. For example, the position sensor 233 may measure the transport speed of the electrode sheet 5S. For example, the second signal S2 may include information regarding the transport speed of the electrode sheet 5S.

The control unit 420 may acquire input signals S1 and S2. The input signals S1 and S2 may include or refer to at least one of the first signal S1 and the second signal S2.

The control unit 420 may generate output signals S3, S4, S5, S6, and S7 based on the input signals S1 and S2. The output signals S3, S4, S5, S6, and S7 may include or refer to at least one of a third signal S3, a fourth signal S4, a fifth signal S5, a sixth signal S6, and a seventh signal S7.

The control unit 420 may control the scanner drive 300. For example, the control unit 420 may control the scanner drive 300 using at least one of the third signal S3, the fourth signal S4, and the fifth signal S5.

For example, the disk unit 310 may operate according to the third signal S3. The third signal S3 may include, for example, command information regarding the operation of the disk motor 312.

For example, the linear drive 320 may operate according to the fourth signal S4. The fourth signal S4 may include, for example, command information regarding the operation of the stator 321.

For example, the cam unit 330 may operate according to the fifth signal S5. The fifth signal S5 may include, for example, command information regarding the operation of the cam motor 332.

The control unit 420 may control the laser 430. For example, the laser 430 may operate according to the sixth signal S6. For example, the sixth signal S6 may include command information regarding the operation of the laser 430.

The control unit 420 may control the mirror assembly 220. For example, the mirror motor 232 may operate according to the seventh signal S7. For example, the seventh signal S7 may include command information regarding the operation of the mirror motor 232.

The control unit 420 may receive position information of the mirror assembly 220 from the position sensor 233 and may control the mirror motor 232 based on the position information.

The position sensor 233 may measure a transport speed of the electrode sheet 5S disposed below the mirror assembly 220 and transported in a direction intersecting the longitudinal direction of the guide rail 120, and the control unit 420 may control the stator 321 based on information regarding the position of the mirror assembly 220 and the transport speed of the electrode sheet 5S.

The contents described above are merely examples of applying the principles of the present disclosure, and other configurations may be further included without departing from the scope of the present disclosure.

What is claimed is:

1. A device for cutting an electrode comprising:
a guide rail extending in a longitudinal direction thereof;
a scanner unit comprising a scanner frame movably coupled to the guide rail and a mirror assembly coupled to the scanner frame; and
a scanner drive coupled to the scanner frame and configured to drive the scanner frame,
wherein the mirror assembly comprises a first mirror that obliquely faces a first laser beam incident while traveling in the longitudinal direction of the guide rail.

2. The device for cutting an electrode according to claim 1, wherein the scanner drive comprises:
a disk motor configured to generate a rotational force;
a coupling disk fixed to the disk motor; and
a coupling rod having one end pivotally coupled to the coupling disk and the other end pivotally coupled to the scanner frame.

3. The device for cutting an electrode according to claim 2, wherein the mirror assembly comprises a second mirror that obliquely faces the first mirror, and
wherein the scanner unit comprises:
a mirror shaft coupled to the second mirror; and
a mirror motor coupled to the mirror shaft.

4. The device for cutting an electrode according to claim 3, wherein a longitudinal direction of a rotational axis of the mirror shaft corresponds to the longitudinal direction of the guide rail.

5. The device for cutting an electrode according to claim 3, wherein the mirror motor is fixed to the scanner frame.

6. The device for cutting an electrode according to claim 3, further comprising a position sensor configured to measure a position of the mirror assembly relative to the guide rail.

7. The device for cutting an electrode according to claim 6, further comprising a control unit configured to receive position information of the mirror assembly from the position sensor and to control the mirror motor based on the position information.

8. The device for cutting an electrode according to claim 2, wherein the coupling disk has a circular disk shape.

9. The device for cutting an electrode according to claim 1, wherein the scanner drive comprises:
a cam motor configured to generate a rotational force; and
a coupling cam fixed to the cam motor and in contact with the scanner frame,
wherein a distance between a point of contact between the coupling cam and the scanner frame and a center of rotation of the coupling cam varies depending on rotation of the coupling cam.

10. The device for cutting an electrode according to claim 9, wherein the coupling cam and the scanner frame are disposed in the longitudinal direction of the guide rail.

11. The device for cutting an electrode according to claim 10, further comprising a pusher configured to apply a force to the scanner frame in a direction from the scanner frame toward the coupling cam.

12. The device for cutting an electrode according to claim 1, wherein the scanner drive comprises:
a stator extending in the longitudinal direction of the guide rail and coupled to the guide rail; and
a mover coupled to the scanner frame and facing the stator.

13. The device for cutting an electrode according to claim 12, wherein when alternating current (AC) power is applied to the stator, a linear force is generated in the mover.

14. The device for cutting an electrode according to claim 12, further comprising a position sensor configured to measure a position of the mirror assembly relative to the guide rail.

15. The device for cutting an electrode according to claim 14, wherein the position sensor comprises:
a linear rod extending in the longitudinal direction of the guide rail; and
a linear lead coupled to the scanner frame and facing the linear rod.

16. The device for cutting an electrode according to claim 14, further comprising a control unit configured to control the stator based on position information of the mirror assembly acquired from the position sensor.

17. The device for cutting an electrode according to claim 16, wherein the position sensor measures a transport speed of the electrode sheet disposed below the mirror assembly and transported in a direction intersecting the longitudinal direction of the guide rail, and
wherein the control unit controls the stator based on information regarding the position of the mirror assembly and the transport speed of the electrode sheet.

18. The device for cutting an electrode according to claim 1, wherein the mirror assembly comprises a second mirror that obliquely faces the first mirror, and
wherein the scanner unit comprises:
a mirror shaft coupled to the second mirror;
a scanner gear fixed to the mirror shaft; and
a guide gear extending in the longitudinal direction of the guide rail and meshed with the scanner gear.

19. The device for cutting an electrode according to claim 18, wherein the scanner gear comprises:
a first scanner gear rotatably coupled to the scanner frame and meshed with the guide gear to rotate when the scanner frame moves; and
a second scanner gear extending from the rotational axis of the mirror shaft and meshed with the first scanner gear.

20. The device for cutting an electrode according to claim 19, wherein a coupling structure between the first scanner gear and the guide gear is a pinion-rack coupling structure, and
wherein a coupling structure between the first scanner gear and the second scanner gear is a bevel-gear coupling structure.
